(19) United States
(12) Patent Application Publication
(10) Pub. No.: US 2010/0202046 A1
(43) Pub. Date: Aug. 12, 2010

(54) DISTINGUISHING 3D TV GLASSES

(75) Inventor: Robert Hardacker, Escondido, CA (US)

Correspondence Address: ROGITZ & ASSOCIATES, 750 B STREET, SUITE 3120, SAN DIEGO, CA, 92101, US

(73) Assignee: SONY CORPORATION and SONY ELECTRONICS INC.

(21) Appl. No.: 12/368,488

(22) Filed: Feb. 10, 2009

(51) Int. Cl. G02B 27/22; G02B 27/26; G02B 7/02

(52) U.S. Cl. 359/464; 359/465; 359/815; 359/462

(57) ABSTRACT

Various ways are provided to visually distinguish one pair of TV 3D glasses from another in a home, including numbering the glasses, providing a white space on each pair of glasses that can be marked, color coding the glasses, and providing a visually unique band for each pair of glasses that can be engaged with the stem of the glasses.

### FIELD OF THE INVENTION

The present invention relates generally to distinguishing 3D TV glasses in a home environment.

### BACKGROUND OF THE INVENTION

If 3D TV is provided, the various occupants of a home typically must don 3D glasses to view video on the TV in pseudo-three dimensions.

### SUMMARY OF THE INVENTION

As understood herein, it would be advantageous to provide a means for distinguishing one home viewer's 3D TV glasses from another viewers.

Accordingly, an apparatus has a lens frame and left and right stems extending parallel to each other from the frame. Each stem is configured to engage a respective human ear. Left and right lens elements are held by the frame with a center-to-center distance approximating the distance between human eyes. Each lens element is a 3D lens element. A visual index is associated with the frame and/or at least one stem to uniquely identify the apparatus from a like apparatus with a different visual index.

The visual index may be numbering, and/or the visual index may include a white space that can be marked. Yet again, the visual index may include color coding by means of a respective color, and/or the visual index can include a respective visually unique band that can be engaged with a stem. The lenses can be polarized lenses, or each lens element can include at least one lens shutter.

In another aspect, a method for distinguishing a first pair of TV 3D glasses from a second pair includes numbering the glasses with respective first and second numerals, and/or providing a respective white space on each pair of glasses that can be marked, and/or color coding the glasses with respective colors, and/or providing a respective visually unique band for each pair of glasses that can be engaged with a stem of a pair.

In another aspect, a system includes TV system with processor, tuner, and display controlled by processor to present video signals from the tuner. First 3D glasses are wearable by a person and are identifiable from first visual indicia associated with the first 3D glasses. Also, second 3D glasses are wearable by a person and are identifiable from second visual indicia associated with the second 3D glasses. The first indicia are different from the second indicia.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view showing a 3D TV with internal components shown schematically, and showing two pair of 3D viewing glasses;

FIG. 2 is a side view partially cut away of a first glasses stem with visually distinguishing means;

FIG. 3 is a side view partially cut away of a second glasses stem with visually distinguishing means; and

FIG. 4 is a side view partially cut away of a third glasses stem with visually distinguishing means.

### DETAILED DESCRIPTION OF THE PREFERRED EMBODIMENT

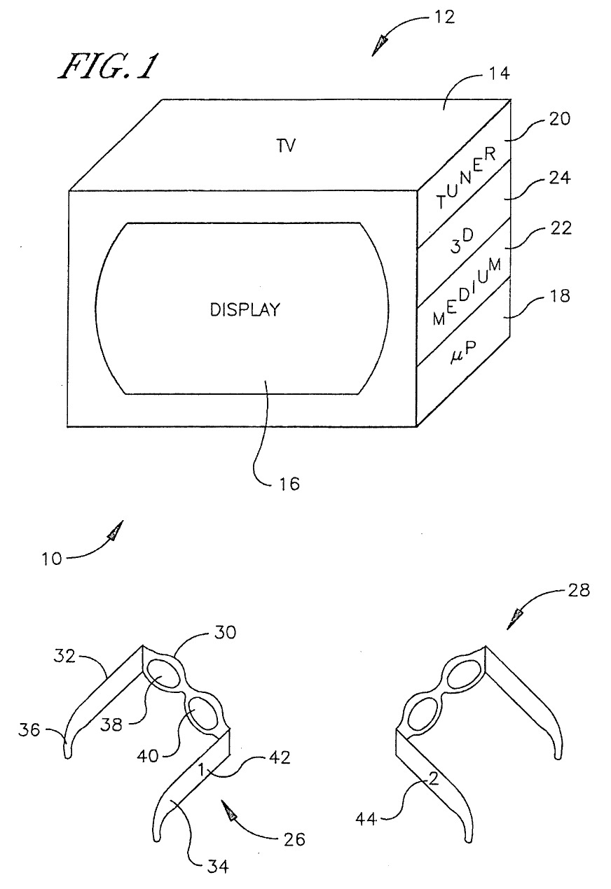

Referring initially to FIG. 1, a system 10 includes a TV system 12 that in one implementation includes a TV chassis 14 holding a TV display 16 such as a standard definition and/or high definition display, e.g., a matrix-type flat panel display. The display 16 under control of a TV processor 18 in the chassis 14 presents signals from a TV tuner 20 in the chassis 14, it being understood that the above components may be implemented in concert with, e.g., a set-top box.

The processor 18 accesses a computer-readable medium 22 such as solid state storage or disk-based storage that in some embodiments may embody a 3D software module 24, which can be executed by the processor 18 to cause a 3D-type image to be presented on the display 16 in accordance with 3D video principles known in the art. To facilitate the 3D experience, a first viewer may wear a first 3D pair of glasses 26 while a second viewer may wear a second 3D pair of glasses 28 that is visually distinguished from the first pair 26 in accordance with principles below. While only two pair 26, 28 are shown for simplicity, present principles apply to a greater number of 3D glasses that may be supplied for 3D viewing.

Except for the different visual indicia, the pair 26, 28 may be substantially identical, so taking the pair 26 as an example, the pair 26 includes a lightweight typically plastic frame 30 that when worn extends across the bridge of the wearer's nose. The frame 30 supports left and right stems 32, 34 extending parallel to each other from the frame 30 in the same direction, with each stem 32, 34 being configured to engage a respective human ear by means of, e.g., a respective end loop 36. The stems 32, 34 may be hinged to the frame 30.

Left and right lens elements 38, 40 are held by the frame 30 with a center-to-center distance approximating the distance between human eyes. Each lens element is a 3D lens element. In one implementation, the lens elements are polarized lenses. In another implementation, each lens element includes at least one lens shutter. An example non-limiting embodiment of such a lens shutter arrangement is shown in U.S. Pat. No. 5,153,569, incorporated herein by reference.

In accordance with present principles, a visual index is associated with the frame 30 and/or at least one stem 32, 34 to uniquely identify the first pair 26 from the second pair 28. As shown in FIG. 1, the visual index may be numbering, e.g., the first pair 26 may be labeled with a “1” or an “A” as shown at 42 whereas the second pair 28 may be labeled with a “2” or a “B” as shown at 44 that is different from the index shown at 42. The numbers or letters 42, 44 may be embossed on a respective stem as shown.

In addition or alternatively, the frame and/or stems of the first pair 26 may be molded of a different color plastic than the frame and/or stems of the second pair 28, or the first pair 26 may be painted a different color than the second pair 28.

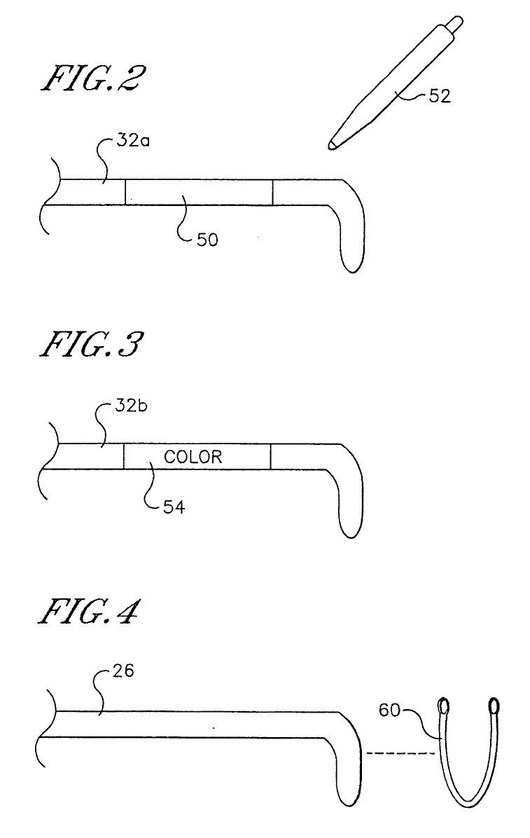

In addition or alternatively, as shown in FIG. 2 on the inside surface of a stem 32a a white matte area 50 may be painted or molded, and a person can use an indelible pen 52 to mark a number or letter or symbol uniquely identifying the stem (and, hence, pair of glasses to which it belongs). Yet again, as shown in FIG. 3 on the inside surface of a stem 32b a respective non-white color area 54 may be painted or molded. Thus, a first pair of glasses may have a blue area 54, a second pair a green area 54, a third pair a red area, and so on with each pair having its own unique color in the area 54.

In addition to or in lieu of the visual indicia above, as shown in FIG. 4 each pair 26, 28 of 3D glasses may be provided with a uniquely identifiable loop or band 60. The loop or band 60 may be elastically deformable to slip onto the stem of the pair 26 and then tightly grip the stem when released, or the loop or band 60 may be inelastic and may simply be slipped over the stem and then glued thereto. In any case, each loop or band 60 is uniquely distinguishable from the other loops or bands of the remaining glasses, e.g., is of a unique color or bears a unique number or letter from the other loops or bands.

While the particular DISTINGUISHING 3D TV GLASSES is herein shown and described in detail, it is to be understood that the subject matter which is encompassed by the present invention is limited only by the claims.

What is claimed is:

1. Apparatus comprising:
lens frame;
left and right stems extending parallel to each other from the frame, each stem configured to engage a respective human ear;
left and right lens elements held by the frame with a center-to-center distance approximating the distance between human eyes, each lens element being a 3D lens element; and
a visual index associated with the frame and/or at least one stem to uniquely identify the apparatus from a like apparatus with a different visual index.

2. Apparatus of claim 1, wherein the visual index is numbering.

3. Apparatus of claim 1, wherein the visual index includes a white space that can be marked.

4. Apparatus of claim 1, wherein the visual index includes color coding by means of a respective color.

5. Apparatus of claim 1, wherein the visual index includes a respective visually unique band that can be engaged with a stem.

6. Apparatus of claim 1, wherein the visual index includes at least two of:
numbering;
a white space that can be marked;
color coding by means of a respective color;
a respective visually unique band that can be engaged with a stem.

7. Apparatus of claim 1, wherein the lenses are polarized lenses.

8. Apparatus of claim 1, wherein each lens element includes at least one lens shutter.

9. Method for distinguishing a first pair of TV 3D glasses from a second pair, comprising:
numbering the glasses with respective first and second numerals; and/or
providing a respective white space on each pair of glasses that can be marked; and/or
color coding the glasses with respective colors; and/or
providing a respective visually unique band for each pair of glasses that can be engaged with a stem of a pair.

10. Method of claim 9, comprising:
numbering the glasses with respective first and second numerals.

11. Method of claim 9, comprising:
providing a respective white space on each pair of glasses that can be marked.

12. Method of claim 9, comprising:
color coding the glasses with respective colors.

13. Method of claim 9, comprising:
providing a respective visually unique band for each pair of glasses that can be engaged with a stem of a pair.

14. Method of claim 10, comprising:
providing a respective white space on each pair of glasses that can be marked.

15. Method of claim 10, comprising:
color coding the glasses with respective colors.

16. Method of claim 10, comprising:
providing a respective visually unique band for each pair of glasses that can be engaged with a stem of a pair.

17. Method of claim 14, comprising:
color coding the glasses with respective colors.

18. Method of claim 17, comprising:
providing a respective visually unique band for each pair of glasses that can be engaged with a stem of a pair.

19. System comprising:
TV system with processor, tuner, and display controlled by processor to present video signals from the tuner;
first 3D glasses wearable by a person and identifiable from first visual indicia associated with the first 3D glasses; and
second 3D glasses wearable by a person and identifiable from second visual indicia associated with the second 3D glasses, the first indicia being different from the second indicia.

20. System of claim 19, wherein the first indicia includes a first number and the second indicia includes a second number.
